(19) United States
(12) Patent Application Publication
(10) Pub. No.: US 2026/0368567 A1
(43) Pub. Date: Nov. 19, 2026

(54) Faithfulness Evaluation

(71) Applicant: Microsoft Technology Licensing, LLC, Redmond, WA (US)

(72) Inventor: Dasha METROPOLITANSKY, Cambridge, MA (US)

(73) Assignee: Microsoft Technology Licensing, LLC, Redmond, WA (US)

(21) Appl. No.: 19/247,207

(22) Filed: Jun. 24, 2025

Related U.S. Application Data
(60) Provisional application No. 63/806,533, filed on May 15, 2025.

(51) Int. Cl. G06N 5/045; G06F 16/34

(52) U.S. Cl. CPC G06N 5/045; G06F 16/345

(57) ABSTRACT

This patent relates to enhancing the reliability of content generated by generative models. Toward this goal, the disclosure provides a trace for the user that shows support for statements made by a generative model. One example can model a multi-stage generative pipeline based upon original source documents as a Directed Acyclic Graph (DAG). This example can represent, in the DAG, the original source documents as root nodes with no incoming edges and language model (LM) generated output as intermediate nodes and a terminal node of the DAG. This example can split the terminal node into claims and can perform faithfulness evaluation on the claims. The faithfulness evaluation can involve attempting to identify a provenance trace from an individual claim through individual intermediate nodes to an individual root node.

### BACKGROUND

In recent years, generative machine learning models have demonstrated tremendous capability at generating content. For instance, generative language models can generate text to summarize existing documents, which is useful, especially for long documents.

### SUMMARY

This patent relates to enhancing the reliability of content generated by generative models. Toward this goal, the disclosure provides a trace for the user that shows support for statements made by a generative model. One example can model a multi-stage generative pipeline based upon original source documents as a Directed Acyclic Graph (DAG). This example can represent, in the DAG, the original source documents as root nodes with no incoming edges and language model (LM) generated output as intermediate nodes and a terminal node of the DAG. This example can split the terminal node into claims and can perform faithfulness evaluation on the claims. The faithfulness evaluation can involve attempting to identify a provenance trace from an individual claim through individual intermediate nodes to an individual root node.

This summary is intended to briefly introduce some of the present concepts. The summary is not intended to be limiting and does not include all of the concepts that are disclosed and claimed below.

### BRIEF DESCRIPTION OF THE DRAWINGS

The accompanying drawings illustrate implementations of the concepts conveyed in the present patent. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the figure and associated discussion where the reference number is first introduced.

FIGS. 1A-1D and 2 show example use-case scenarios for accomplishing verification tracing concepts in accordance with some implementations.

FIG. 3 shows an example architecture configuration for accomplishing verification tracing concepts in accordance with some implementations.

FIGS. 4 and 5 show example tables relating to verification tracing concepts in accordance with some implementations.

FIG. 6 shows an example system relating to verification tracing concepts in accordance with some implementations.

FIG. 7 shows an example generative language model relating to verification tracing concepts in accordance with some implementations.

FIG. 8 shows an example flowchart relating to verification tracing concepts in accordance with some implementations.

### DETAILED DESCRIPTION

### Overview

This patent relates to evaluating the accuracy of artificial intelligence (AI) generated content. In recent years, generative AI models have demonstrated tremendous capability at generating content. For instance, generative language models (LMs) can generate text to summarize existing documents. These summaries are useful to the user, especially for long documents. However, this generated content is only useful to the user if it is accurate and can even be harmful if the user relies on it and it is inaccurate. The present concepts evaluate the accuracy of the generated content via faithfulness evaluation and provenance tracing for processes with multiple generative steps (e.g., multi-stage language model processes). The evaluation ensures the user can rely on the generated content and the user can even review the provenance tracing if they so desire before he/she relies on the content.

As introduced above, two of the most common uses for generative AI models, such as LMs including large language models (LLMs) and small language models (SLMs) are question-answering (QA) and summary generation (SG). Other uses for LMs include document drafting/generating and/or editing. These use cases are especially valuable when working with very long documents or large collections of documents, which may be referred to herein as MLD (Many and/or Long Documents).

For these use cases over MLD, the processes with multiple generative steps are becoming increasingly popular. At a high level, this involves compressing source material through multiple stages of LM outputs before arriving at a final answer or summary. Some examples include hierarchical summarization, graph-based retrieval augmented generation (RAG) (e.g., graph-based RAG), and multi-agent systems, among others.

Hierarchical summarization involves chunking documents. Each chunk is summarized by a LM. The resulting summaries are grouped and summarized until only a final summary remains. For instance, this can be used to summarize entire novels.

Graph-based RAG, such as Microsoft Corporation's GraphRAG involves the LM extracting entities and relationships from the source text. In some versions, a knowledge graph is constructed and communities are identified via non-LM steps. The LM then summarizes each community. At query time, intermediate answers are generated for groups of communities, which are then used to generate a final answer. For comparison, standard Retrieval Augmented Generation (RAG) is generally not viewed as a process with multiple generative steps because it typically involves only a single LM generation step.

Multi-agent systems include individual agents that process specific documents or sub-questions either in sequence or in parallel. A final agent synthesizes their outputs into a final response.

One of the key requirements for generative processes is that their outputs should be faithful to the source material. However, in multi-stage generative processing systems-especially at MLD scale-verifying faithfulness is extremely challenging. For example, applying hierarchical summarization to a long novel may result in hundreds of intermediate summaries. The present concepts involve technical solutions about the summaries. For instance, the technical solutions indicate which parts of the final summary are consistent with the original text, and which are not. For the consistent parts, the technical solutions can trace their provenance through each stage of the system back to the original text. This is useful for several purposes, such as so that a human reviewer can easily verify the result. For the inconsistent parts, the technical solutions can pinpoint where the system went wrong (e.g., identify the specific summarization steps that introduced errors). This is useful for various purposes, such as improving reliability of future runs through the LM. The present concepts can address all these objectives, among other advantages.

Implementations of the technical solutions can model processes with multiple generative steps (e.g., a multi-stage generative pipeline) as a Directed Acyclic Graph (DAG). In the DAG, root nodes (i.e., nodes with no incoming edges) represent the original source documents, typically split into chunks (each chunk is a node). Other nodes represent non-source material, such as LM-generated outputs. Edges indicate that a node was used as context/input in generating another node. The final answer or summary is the terminal node (i.e., a node with no outgoing edges).

The DAG can be organized into stages, defined from the bottom up. For instance, in one configuration Stage 0 includes all root nodes, Stage 1 includes nodes with inputs from Stage 0 (or other Stage 1 nodes), and so on, up to Stage n, which contains the terminal node. In other configurations, such as GraphRAG the stages correspond to distinct step types (stage 1=raw text chunks; stage 2=entities and relationships; stage 3=summarized entities and relationships; stage 4=community reports; stage 5=map answers; stage 6=final answer). In other configurations, like hierarchical summarization, there are multiple possible ways to assign stages. Thus, note that some of these configurations allow the user to decide how to assign stages to nodes. The evaluation process begins by splitting the terminal node into individual claims, or key points. The following steps are applied independently to each claim and include evidence gathering, verdict generation, and recursive (e.g., iterative) backtracking.

The first step relates to evidence gathering. The evidence gathering starts with the stage n−1 nodes that were used as context to generate the terminal node. The text corresponding to these nodes is split into chunks, and every text segment in a chunk is assigned a unique ID. The term “text segment” refers to a portion of text content, such as a phrase, sentence, etc. In some implementations the text segment is a contiguous portion of text content. In this example, the text segments that are utilized are sentences.

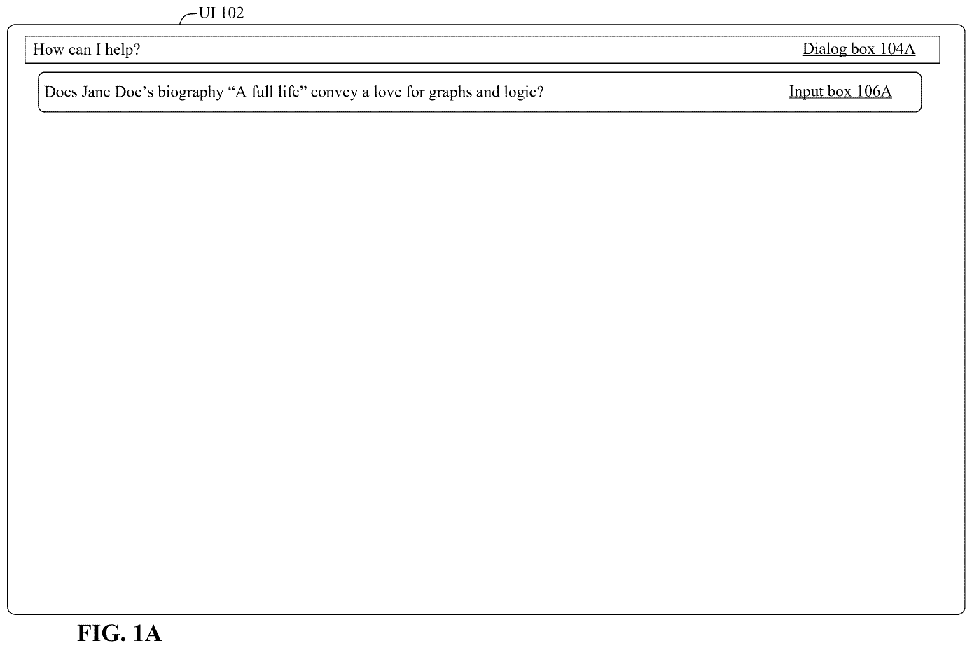

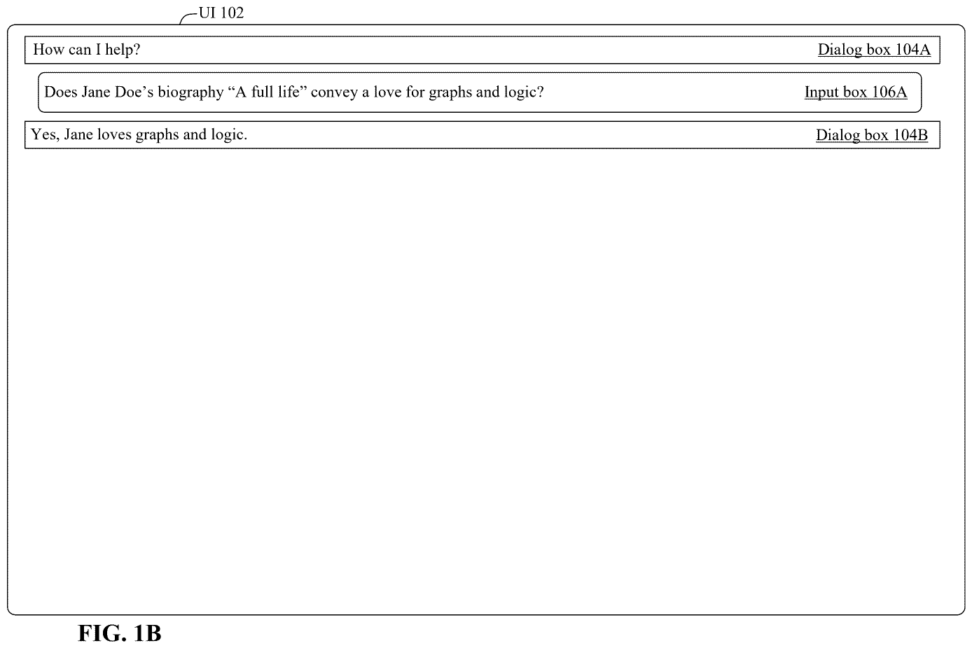

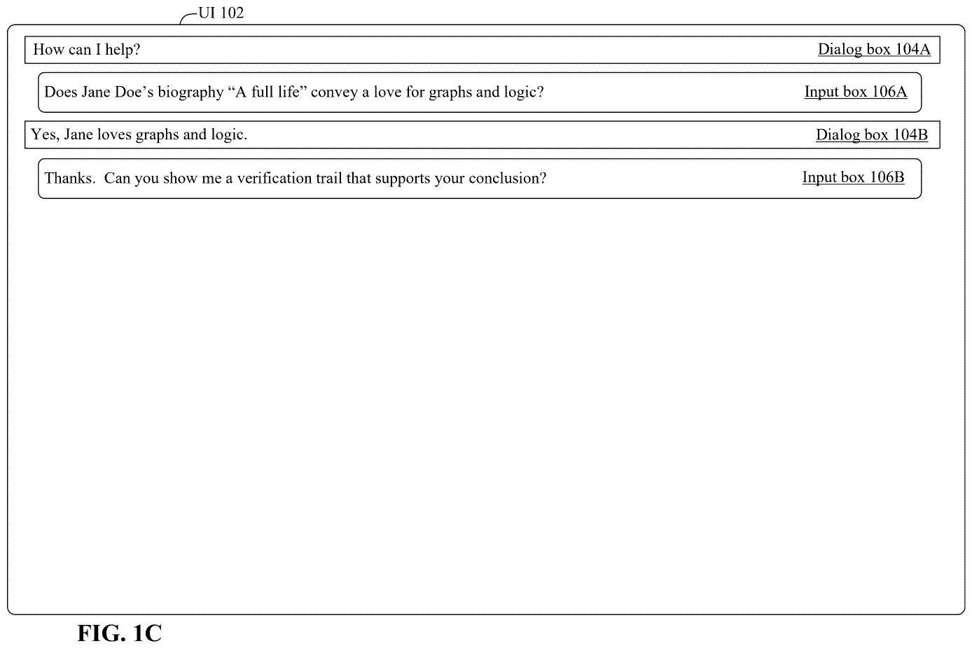

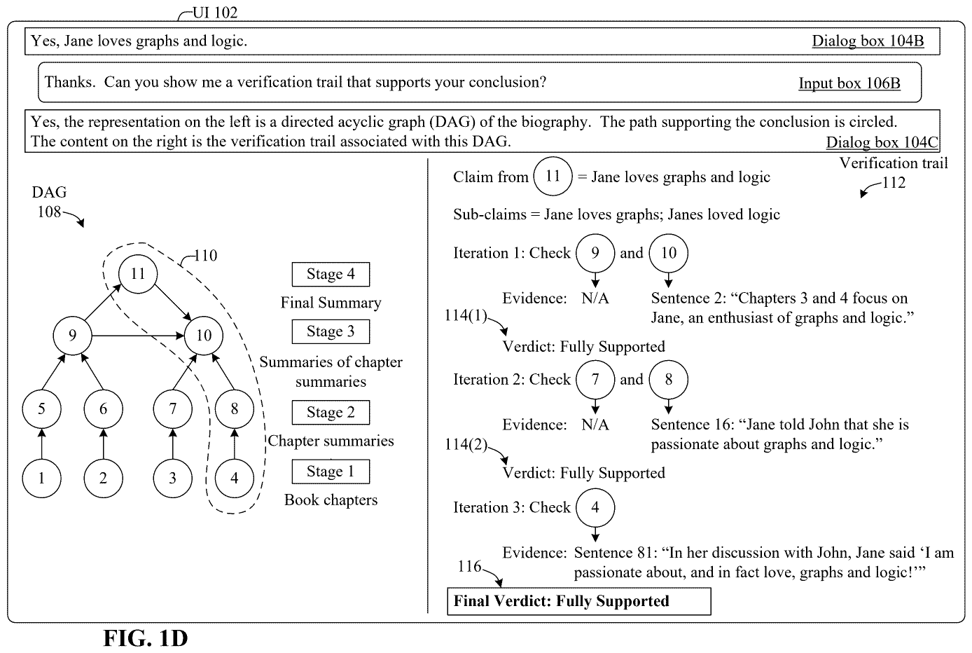

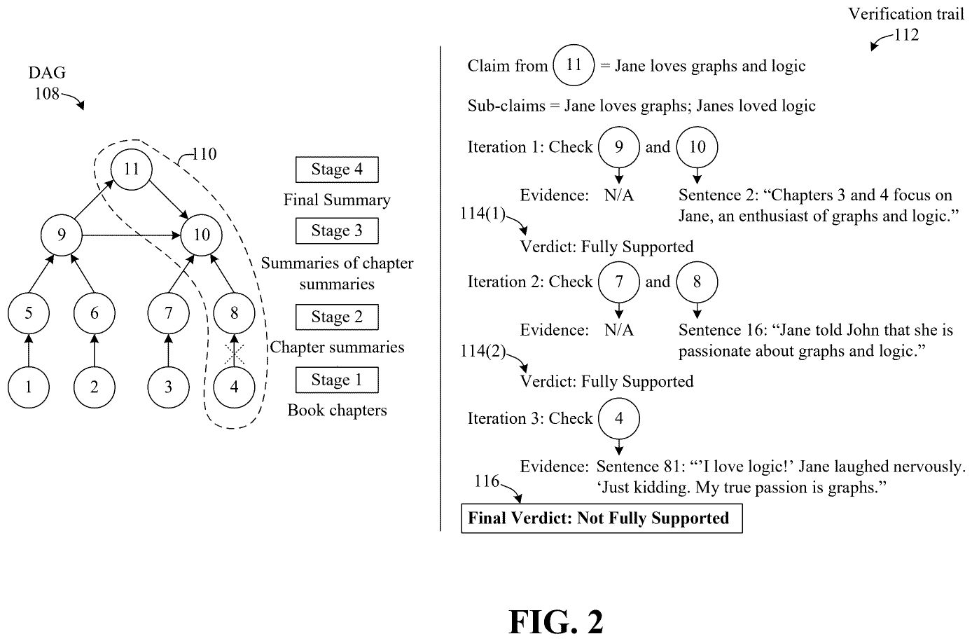

For each chunk, an LM is prompted to: (a) identify sentence IDs that strongly support or refute at least part of the claim, and (b) generate a summary based on the selected sentences, if any. In some configurations, if no sentences are selected across all chunks, the claim is labeled “not fully supported” and the process may end for this claim. Otherwise, the method proceeds to the next step, which involves verdict generation. Alternative configurations are described below relative to FIGS. 1A-1D and 2.

In some configurations, verdict generation involves giving the LM the generated summaries and prompting the LM to return a verdict. In this example, the verdict entails labels, such as ‘fully supported,’ ‘not fully supported,’ or ‘inconclusive’ that are associated with the claims. If the summaries do not fit in the LM's context window or a lesser configurable input size limit, the system repeats evidence gathering—this time using the summaries as input instead of the original content—until either (a) the summaries fit, or (b) a maximum recursion depth is reached. If the verdict is not fully supported, the process may end. Alternative configurations are described below relative to FIGS. 1A-1D and 2.

The next stage involves iterative backtracking. If the verdict is fully supported, the process continues by moving one stage down the graph. Specifically, the process identifies the subset of stage n−1 nodes from which at least one sentence was selected as relevant during evidence gathering. For each of these nodes, the process identifies their source nodes (i.e., the nodes used as context during their generation, typically from stage n−2). The method then repeats the same evidence gathering and verdict generation steps on these source nodes. In some configurations, this iterative process continues until either (a) the claim is found to be not fully supported at an intermediate stage, or (b) the process reaches the root document chunks (Stage 0), where a final verdict is issued based directly on the original source material. Alternative configurations are described below relative to FIGS. 1A-1D and 2.

For each claim, the final outputs are verdicts and evidence trails. The verdicts include a verdict on whether the claim is justified, along with the reasoning. This includes the verdict reached at every stage that was checked (e.g., the results of all verdict generation steps). The evidence trail shows (a) the exact sentences selected (if any) at each stage, (b) the node IDs associated with each extracted sentence, (c) the summaries generated from those sentences. Note that the verdicts can be presented with the evidence trail for purposes of explanation and/or the verdicts can be viewed as freestanding aspects that show error localization.

Most existing methods for evaluating faithfulness are designed for QA/SG systems with only a single generative step process: the source documents are directly used to generate a final answer or summary. In contrast, the present technical solutions perform faithfulness evaluation across multiple generative step processes. Note that the technical solution still works for single-stage systems; the DAG will just have two stages. A key technical advantage is that at each stage of the verification process, only the subset of upstream nodes that contributed relevant evidence is further explored. This avoids unnecessary checks, improving efficiency and scalability, while reducing resource usage.

### Example Use Case

FIGS. 1A-1D collectively show an example use-case scenario involving faithfulness evaluation. This example relates to a user-interface (UI) 102 where a user can interact with a generative model, such as a language model. This UI includes language model generated dialog boxes 104 alternating with user input boxes (prompt boxes) 106.

FIG. 1A shows dialog box 104A where the language model asks, ‘How can I help?’ The user asks in input box 106A ‘Does Jane Doe's biography ‘A full life’ convey a love for graphs and logic?′ FIG. 1B adds the language model's response in dialog box 104B. The language model responds, ‘Yes, Jane loves graphs and logic.’ With existing technologies, the user can do what he/she wants with the answer, but always has doubts about its reliability. Advantages over the existing technology are explained relative to FIGS. 1C and 1D.

FIG. 1C shows a subsequent UI 102 where the user asks in input box 106B ‘Can you show me a verification trail that supports your conclusion?’

FIG. 1D shows a subsequent UI 102, where the language model responds to the user request for a verification trail, ‘Yes, the representation on the left is a directed acyclic graph (DAG) of the biography. The path supporting the conclusion is circled. The content on the right is the verification trail associated with this DAG.’ The lower left of the UI shows DAG 108 with the circled verification trail path at 110. The lower right shows verification trail 112 corresponding to the DAG 108. The verification trail 112 shows support between stages as iterations 1, 2, and 3. (Other DAGs could have different numbers of stages).

The verification trail 112 includes intermediate verdicts 114 between two sets of adjacent stages along with the supporting evidence and culminates in a final verdict 116. In this example, each iteration is supported and as such receives a fully supported intermediate verdict 114 and ultimately a fully supported final verdict 116. This verification trail and associated DAG allows the user to see how the book was summarized into several layers and the support for the conclusion all the way from the top layer to the original text in the book. Thus, the user can be very confident in the language model's conclusion. Further, in some configurations, if they desire, the user can evaluate the cited sections supporting each verdict along the verification trail. For instance, the user could click on the cited sentence and could be shown the sentence and the surrounding text to review. For purposes of explanation and comparison, FIG. 2 shows a similar example where the language model's conclusion was not fully supported.

FIG. 2 shows another DAG 108 and verification trail 112 that are similar to those illustrated in FIG. 1D. However, for purposes of explanation, the content has been slightly changed. In this case, iterations 1 and 2 are fully supported as indicated by intermediate verdicts 114(1) and 114(2). However, in relation to iteration 3, the supporting evidence is sentence 81 from the original book chapters, which says “‘I love logic!’ Jane laughed nervously. ‘Just kidding. My true passion is graphs.” This text does not support the quote in sentence 16 that “Jane told John that she is passionate about graphs and logic.” As such, the final verdict 116 is listed as not fully supported. In relation to the DAG 108, an ‘X’ between claims 4 and 8 conveys the lack of sufficient support. In both cases, the affirmative of FIG. 1D or the negative of FIG. 2, the present concepts provide more information about the reliability of generative model answers than existing technologies. This information can be leveraged in multiple ways.

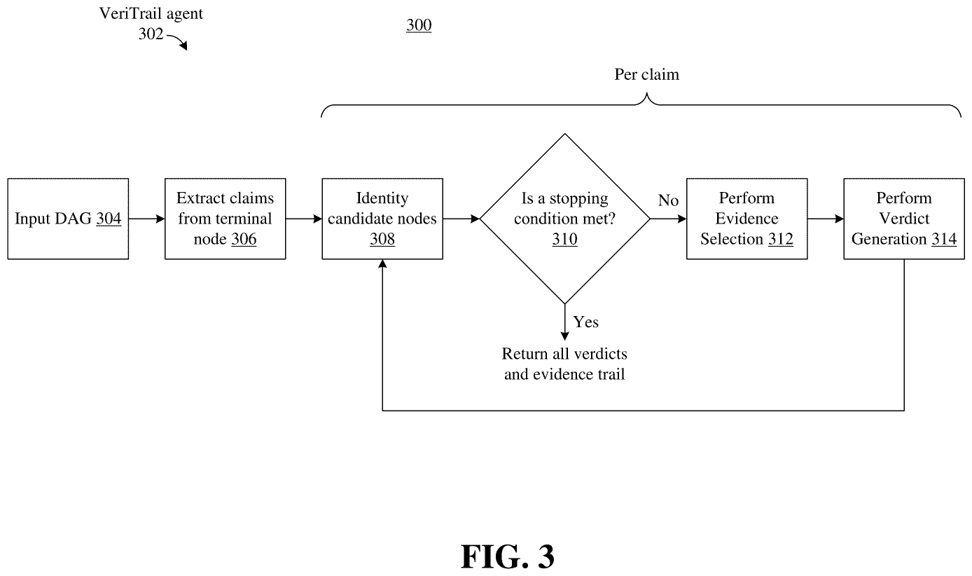

FIG. 3 shows an example architectural flow 300 that shows how a VeriTrail agent 302 can accomplish the present concepts. The VeriTrail agent starts with the input DAG 304. The VeriTrail agent extracts claims from the terminal node at 306 of the DAG. The VeriTrail agent identifies candidate nodes at 308. The VeriTrail agent then determines whether a stopping condition is met at 310. If not, the VeriTrail agent performs evidence selection at 312. The VeriTrail agent performs verdict generation at 314. The process returns to identifying candidate nodes and the process repeats (on a per claim basis) until a stopping condition is met at 310. At this point, the VeriTrail agent has obtained all verdicts and the evidence trail. These aspects are described in more detail above and below.

### Example Configuration

As introduced above, LMs are widely used to generate content based on source text. However, even when instructed to adhere to the source, LMs are known to produce unsupported content-a phenomenon known as “closed-domain hallucination.” Detecting hallucination is important in many settings (e.g., a doctor seeking guidance from medical literature, a lawyer summarizing precedent cases, a customer service agent answering questions based on policy documents). Closed-domain hallucination detection (or shortened to “hallucination detection”) is also known as “faithfulness evaluation”—and this disclosure uses both terms interchangeably.

Processes that use LMs to generate content based on source material can be divided into two categories: single generative step (SGS) processes and multiple generative step (MGS) processes. In SGS processes, the LM does not generate any intermediate outputs prior to the final output. Since these processes are constrained by the LM's context window, they may be less reliable when applied to long documents or large collections of documents. If the source material exceeds the LM's context window, truncation or retrieval is required, risking information loss. Even as newer LMs support larger context windows, LMs still struggle to reason over large inputs.

Given the limitations of SGS processes, applications of LMs increasingly rely on MGS processes, where intermediate outputs generated by the LM are used as inputs to subsequent steps. In MGS processes, since the source material or the task can be split into smaller, more manageable parts, truncation or retrieval may not be necessary, reducing the risk of information loss. However, MGS processes may increase the likelihood of hallucinations, as each step presents an additional opportunity for errors to arise and propagate. Therefore, as the use of MGS processes accelerates, effective hallucination detection methods become increasingly important.

However, detection alone is not enough. In many settings, users benefit by understanding how the output may have been derived from the source (provenance) and where errors may have been introduced (error localization). This understanding is valuable both to data scientists trying to improve performance and to end users who rely on the output. Provenance helps users verify and trust the output, while error localization is critical for correcting hallucinations and understanding which parts of the process are most error-prone. This disclosure refers to provenance and error localization collectively as traceability. The transparency enabled by traceability is especially important for MGS processes due to their complexity.

Prior works frame faithfulness evaluation as comparing a given LM output to the source material. This approach implicitly assumes there is only a single output to evaluate and does not distinguish between intermediate and final outputs. For SGS processes, this simplification is reasonable since there is only one generative step, comparing its output to the source is sufficient both to assess faithfulness and to provide traceability. In MGS processes, however, while the final output can still be compared to the source to determine whether hallucination occurred, traceability cannot be achieved without the intermediate outputs.

This disclosure provides several technical solutions. First, the present concepts provide a conceptual framework that provides a unified representation of diverse generative processes for the purpose of faithfulness evaluation. Second, the present concepts provide the first closed-domain hallucination detection method to provide traceability for MGS and SGS processes. For brevity this closed-domain hallucination detection method may be referred to as ‘VeriTrail.’ VeriTrail outperforms baseline methods in hallucination detection. Third, the present concepts provide the first datasets to include all intermediate outputs as well as human annotations of final outputs' faithfulness for their respective MGS processes. For sake of brevity these datasets may be referred to as ‘FABLES+’ and ‘DiverseSumm.’

The conceptual framework can include defining a non-generative step as an operation that outputs only unmodified text spans from the input. In contrast, a generative step may modify the input text or introduce new information. Steps involving LMs are typically generative, although exceptions exist (e.g., constrained decoding).

A generative process is a sequence of steps that produces a final output from a set of source documents D and must include at least one generative step. At each step, the input consists of text spans from D and/or outputs from earlier steps.

Generative processes can be categorized as containing either a single generative step (SGS) or multiple generative steps (MGS). An example of an SGS process is Retrieval-Augmented Generation (RAG) where a non-generative retrieval system selects a subset of the source material to provide as input to a LM: although this process involves two steps, only one is generative. Two examples of MGS processes are hierarchical summarization and GraphRAG.

The present technical solutions model a generative process as a directed acyclic graph (DAG) G=(V,E), where each node v∈V represents a text span, either originating from D or produced by a step. Each directed edge (u,v)∈E indicates that node u was included as an input to the step that produced node v.

For any node v, the present solutions can define its source nodes as src(v)={u∈V|(u,v)∈E}—the set of nodes used as input to produce v. Root nodes V0⊆V have no incoming edges (i.e., ∀v∈V0, src (v)=Ø) and correspond to text spans from D. The terminal node v*∈V has no outgoing edges and represents the final output. Any node that is neither a root node nor the terminal node is referred to as an intermediate node.

A function stage: V→ [symbol] that assigns a stage to each node, can be defined such that for every edge (u,v)∈E, stage (v)≥stage(u). Conceptually, the stage reflects a node's position in the generative process. Root nodes are assigned the minimal stage, and the terminal node is assigned the maximal stage. For intermediate nodes, some processes (e.g., GraphRAG) have clearly defined stage assignments due to distinct step types, while others (e.g., hierarchical summarization) do not have a single “correct” assignment.

Faithfulness evaluation aims to determine whether the terminal node v* is fully supported by the root nodes that have a path to v*. Intuitively, these root nodes represent the subset of the source material that could have contributed to the final output through the generative process.

FIGS. 1A-3 show example VeriTrail configurations. As noted above, VeriTrail is a closed-domain hallucination detection method. FIGS. 1A-3 also show the VeriTrail verification process, which is also detailed in Algorithm 1.

In relation to claim extraction, VeriTrail takes as input a DAG representing a completed generative process. VeriTrail then uses Claimify or other chunking mechanism/service to extract a set of factual claims C from the terminal node v*, where each claim is a self-contained, verifiable statement. Each claim c∈C is processed independently in steps relating to sub-claim decomposition, evidence selection, verdict generation, and iteration.

In relation to sub-claim decomposition, VeriTrail applies Claimify's decomposition module to each claim c, attempting to rewrite it as a set of simpler sub-claims. If multiple sub-claims are returned, they are added to a queue and recursively decomposed. If only a single sub-claim is returned, no further decomposition is attempted. To prevent infinite loops, VeriTrail skips previously processed sub-claims and enforces a maximum number of decomposition attempts. Sub-claims are retained as context for the evidence selection step but are not verified directly.

Algorithm 1 details an example VeriTrail verification procedure for a single claim c. The procedure assumes access to a DAG G=(V,E) representing a generative process, including the terminal node v*, root nodes V0, and the source function src.

Algorithm 1 VeriTrail

Require: claim c, mac NotFullySupported iterations q

| | |
|---|---|
| 1: | evidence_trail ← [ ] |
| 2: | consec_not_supp ← 0 |
| 3: | checked ← Ø |
| 4: | roots_with_ev ← Ø |
| 5: | all_verdicts ← [ ] |
| 6: | nodes_to_check ← src(v*) |
| 7: | while true do |
| 8: | (evidence, nodes_with_ev) ← get_evidence(c,nodes_to_check) |
| 9: | if evidence = Ø then |
| 10: | verdict ← NotFullySupported |
| 11: | else |
| 12: | add evidence to evidence_trail |
| 13: | roots_with_ev ← roots_with_ev ∪ (nodes_with_ev ∩ V₀) |
| 14: | verdict ← get_verdict(c, evidence, nodes_with_ev) |
| 15: | end if |
| 16: | add verdict to all_verdicts |
| 17: | checked ← checked ∪ nodes_to_check |
| 18: | if verdict = NotFullySupported then |
| 19: | consec_not_supp ←consec_not_supp + 1 |
| 20: | nodes_to_check ← ∪_{n∈nodes}_{_{—}}ₜₒ_{_{—}}_{check} src(n) |
| 21: | else |
| 22. | consec_not_supp ← 0 |
| 23: | nodes_to_check ← ∪_{n∈nodes}_{_{—}}_{with}_{_{—}}ₑᵥ src(n) |
| 24: | end if |
| 25: | nodes_to_check ← (nodes_to_check \checked) ∪ |
| | roots_with_ev |
| 26: | if nodes_to_check = roots_with_ev then |
| 27: | break |
| 28: | end if |
| 29: | if nodes_to_check = Øthen |
| 30: | verdict ← NotFullySupported |
| 31: | break |
| 32: | end if |
| 33: | if consec_not_supp = q then |
| 34: | break |
| 35: | end if |
| 36: | end while |
| 37: | return (verdict, evidence_trail, all_verdicts) |

In relation to evidence selection, VeriTrail identifies src (v*)—the set of nodes used as input to produce the terminal node. Each source node is segmented into sentences using NLTK's sentence tokenizer, and each sentence is programmatically assigned a unique ID. An LM is prompted to select all sentences that strongly imply the truth or falsehood of c or any of its sub-claims. The LM returns the selected sentence IDs and a summary of their content.

In relation to verdict generation, if no sentences were selected in the evidence selection step, c is tentatively assigned a “Not Fully Supported” verdict. Otherwise, an LM is prompted to assign one of three verdicts to c: “Fully Supported,” “Not Fully Supported,” or “Inconclusive.” Selected sentences are not included in the verdict prompt directly, as they may be uninterpretable, ambiguous, or misleading out of context. Instead, VeriTrail determines the input based on each node from which at least one sentence was selected: if the node is a root node, its full content is included in the verdict prompt; otherwise, the summary generated during evidence selection is used.

After the initial iteration of evidence selection and verdict generation, subsequent iterations depend on the latest verdict and a hyperparameter q, which specifies the maximum number of consecutive “Not Fully Supported” verdicts. If the latest verdict was “Fully Supported” or “Inconclusive,” VeriTrail identifies the source nodes of all nodes from which sentences were selected in the latest evidence selection step (instead of src (v*) as in the initial iteration). If the latest verdict was “Not Fully Supported” and q has not been reached, VeriTrail identifies the source nodes of the latest nodes that were verified. In both cases, VeriTrail continues evidence selection and verdict generation, using the identified nodes as input for evidence selection.

In some configurations, iteration terminates and a final verdict is assigned to c when one of the following conditions is met: (1) the set of identified nodes is empty (i.e., if the latest verdict was “Fully Supported” or “Inconclusive,” then the nodes from which evidence was selected were all root nodes; if the latest verdict was “Not Fully Supported,” then the verified nodes were all root nodes); (2) all identified nodes have already been verified; or (3) the number of consecutive “Not Fully Supported” verdicts has reached q.

FIGS. 1D and 2 illustrate such examples. The left side of these FIGS. shows a hierarchical summarization as a DAG. The right side shows VeriTrail's verification process. The evidence trail includes sentence 2 from node 10, sentence 16 from node 8, and sentence 81 from node 4. Evidence summaries are not shown.

In relation to traceability, for each claim extracted from v*, VeriTrail returns (1) a final verdict, along with the LM's reasoning; (2) interim verdicts; and (3) an evidence trail composed of selected sentences with their corresponding node IDs and summaries generated during all iterations of evidence selection.

As mentioned above, the evidence trail can provide provenance and the interim verdicts can provide error localization. In relation to provenance, for claims whose final verdict is “Fully Supported” or “Inconclusive,” the evidence trail documents a path through the intermediate nodes to the root nodes. In relation to error localization, for claims deemed “Not Fully Supported,” the interim verdicts are used to identify error stage(s)—the stage(s) where the unsupported content was likely introduced.

To find the error stages, VeriTrail identifies iteration n, the last iteration where the claim received an interim “Fully Supported” verdict prior to the final “Not Fully Supported” verdict. Let Vₑ(n) denote the set of nodes from which at least one sentence was selected during the evidence selection step in iteration n. The error stages are then defined as the stages of the nodes from which sentences were selected during evidence selection in iteration n, excluding root nodes: {stage(v)|v∈Vₑ(n), v∉V₀}. For example, in FIG. 2, the last iteration that received a “Fully Supported” verdict before the final “Not Fully Supported” verdict was iteration 2. In iteration 2, evidence was selected only from node 8, which belongs to stage 2. Therefore, the error stage is stage 2.

The description now highlights five features that contribute to VeriTrail's reliability, efficiency, and scalability. The five features are evidence quality control, input size controls, selective verification, termination control, and reverse traversal.

In relation to evidence quality control, during evidence selection, an LM selects evidence by returning sentence IDs, which are checked against programmatically assigned IDs. If a returned ID does not match an assigned ID, it is discarded; otherwise, it is mapped to its corresponding sentence. This approach guarantees that the sentences included in the evidence trail are not hallucinated. Additionally, identifying specific sentences is arguably more informative than classifying entire nodes as relevant or not. It also simplifies human verification: reviewing a selection of relevant sentences requires less effort than reading full passages.

In relation to input size controls, VeriTrail supports generative processes with any number of nodes, regardless of whether they fit in a single prompt. Users can specify an input size limit per prompt; if no limit is set, it defaults to the LM's context window size. For evidence selection, if the input exceeds the limit, it is split across multiple prompts. For verdict generation, all evidence must be included in a single prompt. If the evidence exceeds the limit, VeriTrail reruns evidence selection on the previously selected evidence. The maximum number of reruns is configurable; if the maximum is reached and the latest evidence exceeds the limit, the largest fitting subset of the evidence is used.

In relation to selective verification, at each iteration, VeriTrail verifies only the source nodes of nodes from which evidence was previously selected, often substantially limiting the number of nodes the LM must evaluate.

In relation to termination control, recall the hyperparameter q, defined above. By enabling early termination, lower values of q result in reduced cost and latency. However, early termination may increase the risk of false positives (i.e., a claim may be deemed hallucinated based on intermediate nodes when it is in fact supported by the source nodes.) There are two main reasons false positives may arise: (1) the interim “Not Fully Supported” verdict was an error, or (2) the claim was supported in the source nodes but omitted from intermediate nodes and later reintroduced. Increasing q reduces the risk of false positives by requiring repeated confirmation that the claim is hallucinated. Therefore, q allows the user to find the desired balance between computational cost and risk of false positives.

In relation to reverse traversal, VeriTrail performs verification in the reverse direction of the generative process: it starts from the source nodes of the terminal node v* and moves towards the root nodes v0. Since selective verification progressively narrows the search space and a low q value enables early termination, VeriTrail tends to verify a larger proportion of nodes in later stages (closer to v*) than in earlier stages (closer to v0). Since earlier-stage nodes are typically larger (e.g., a book chapter is larger than a chapter summary), verifying fewer nodes reduces computational cost.

The description now turns to experimental testing and data. One of the primary objectives of experimentation was to evaluate VeriTrail's performance across different MGS processes and source document types. While many existing datasets provide human annotations of faithfulness for LM-generated outputs, few are based on MGS processes, and none of these include all intermediate outputs. To address this gap, two new datasets were constructed. The first dataset is FABLES+ and the second is DiverseSumm+.

FABLES+ is based on FABLES, a dataset of book summaries generated via hierarchical summarization. Since the original dataset did not preserve all intermediate outputs required to construct the DAG input for VeriTrail, the process re-generated summaries for 22 books (average book length=118K tokens). The process extracted 734 claims from the final summaries using Claimify. In this case, the process identified that 48% of the extracted claims restated information that had already been deemed faithful in the original dataset. As a result, these claims were labelled as faithful without further annotation. The process then annotated the remaining claims.

DiverseSumm+ is based on DiverseSumm, which is a dataset of news stories (e.g., the Russia-Ukraine conflict), each paired with 9-10 articles and a set of questions answered by multiple articles. This example involved retaining 148 stories and 1,479 articles (1.19M tokens). The process sampled 20 questions and generated answers using GraphRAG over the full article set, then extracted 560 claims from the answers using Claimify. To label each claim's faithfulness, the process involved recruiting four annotators through Upwork, who had access to the 9-10 articles associated with each claim. One of the authors served as a fifth annotator with access to the full article set. Only 13% of claims required evidence beyond the 9-10 articles.

The process compared VeriTrail against three types of methods that are commonly used to evaluate faithfulness and capable of processing large source texts. These three method types include Natural Language Inference (NLI), AlignScore, and INFUSE.

NLI methods classify a claim as entailed, contradicted, or neutral with respect to a source document. The process involved selecting two methods that perform well on widely-used NLI benchmarks and represent the main strategies for applying NLI to long inputs: chunk- and sentence-level prediction.

AlignScore splits the document into chunks and computes the probability that each chunk entails the claim. The process aggregated these probabilities using the mean of the top-k values, testing k∈[1, 15].

INFUSE ranks document sentences based on bi-directional entailment (i.e., the probability that the sentence entails the claim or vice versa). It constructs an evidence set by adding top-ranked sentences until the neutral class probability begins to increase. The final entailment probability is computed over this evidence set.

To convert AlignScore and INFUSE probabilities into binary labels, the process involved testing thresholds τ∈{0.5, 0.6, 0.7, 0.8, 0.9}: a claim was labeled “Fully Supported” if the entailment probability was at least τ, and “Not Fully Supported” otherwise.

In relation to retrieval augmented generation (RAG), the process reused the document chunks created during dataset construction. Claims and chunks were embedded using OpenAI's text-embedding-3-large model. For each claim, the process retrieved the top-k most similar chunks, which were passed to an LM for verdict generation. For retrieval, the process used Faiss' k-nearest neighbors search with L2 distance, testing k∈{1, 3, 5, 10, 15, 20, 25}.

In relation to Long-Context LMs, the process involved providing the source document(s)—a full book for FABLES+ and all 1,479 articles for DiverseSumm+-directly to an LM for verdict generation. The process involved testing two models with long context windows: Gemini 1.5 Pro (2M tokens) and GPT-4.1 mini (~1M-tokens). Since the DiverseSumm+articles exceeded GPT-4.1 mini's context window, each time the process evaluated a claim, the articles were randomly shuffled and the largest subset that fit (typically ~80%) was selected.

The results were obtained from evaluating VeriTrail and baseline methods in two settings: hard prediction, where each method outputs a single label per claim (“Fully Supported” or “Not Fully Supported”), and soft prediction, where methods produce a continuous score representing the probability that a claim is fully supported.

This report includes results for AlignScore, INFUSE, and RAG using the best-performing hyperparameter configuration on each dataset. For RAG, Gemini 1.5 Pro, and GPT-4.1 mini, the process involved using VeriTrail's verdict generation prompt. An alternative prompt from the FABLES paper (including for VeriTrail) was also tested. The alternative prompt yielded worse results for all methods except GPT-4.1 mini on FABLES+.

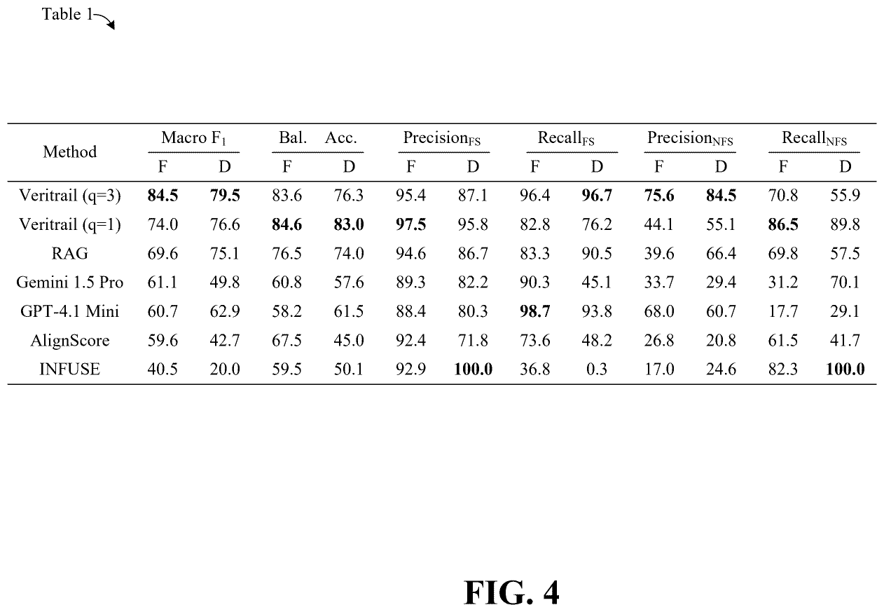

FIG. 4 shows Table 1. This table shows hard prediction results for FABLES+ and DiverseSumm+, respectively. The process used macro F1 and balanced accuracy as the primary metrics. For VeriTrail, results are reported for q=1 and q=3. All VeriTrail and RAG results in Table 1 were produced using OpenAI's gpt-4o-2024-0806 model. On the primary metrics, VeriTrail outperformed all baseline methods for both datasets and all models tested, except for mistral-large-2411, where VeriTrail had the highest balanced accuracy but not the highest macro F1. VeriTrail also outperformed all baselines in the soft prediction setting.

This description includes analysis of which factors contributed to VeriTrail's performance gains. As noted above, all LM-based methods used the same verdict prompt, so VeriTrail's verdict generation step cannot explain why it outperformed the baseline methods. Instead, VeriTrail differs from the baselines in two key ways: (1) it traces claims through intermediate outputs rather than checking them directly against the source material, and (2) it uses LM-based evidence selection prior to verdict generation.

To isolate the contribution of each component, the process involved creating a variant of VeriTrail that retained its tracing mechanism and verdict prompt but replaced its LM-based evidence selection step with the embedding-based retrieval approach used in RAG, the best-performing baseline. At each iteration, this variant retrieved the top-k nodes most similar to the claim and used them as input for verdict generation. The process tested k∈{5, 15, 25}. If the verdict was “Not Fully Supported,” verification terminated (as in the original VeriTrail with q=1); otherwise, the source nodes of the retrieved nodes were evaluated in the next iteration.

This variant is referred to as VT-RAG (VeriTrail-RAG hybrid) and is compared to the original VeriTrail with q=1 (VT) and RAG. These methods can be summarized as follows:
VT=tracing+LM-based Evidence Selection
VT-RAG=tracing+embedding-based Evidence Selection
RAG=no tracing+embedding-based Evidence Selection

If tracing through intermediate outputs is the primary driver of VeriTrail's performance gains, VT≈VT-RAG>RAG can be expected. If LM-based Evidence Selection is the primary driver, VT>VT-RAG and VT>RAG can be expected. If both factors contribute, VT>VT-RAG>RAG can be expected.

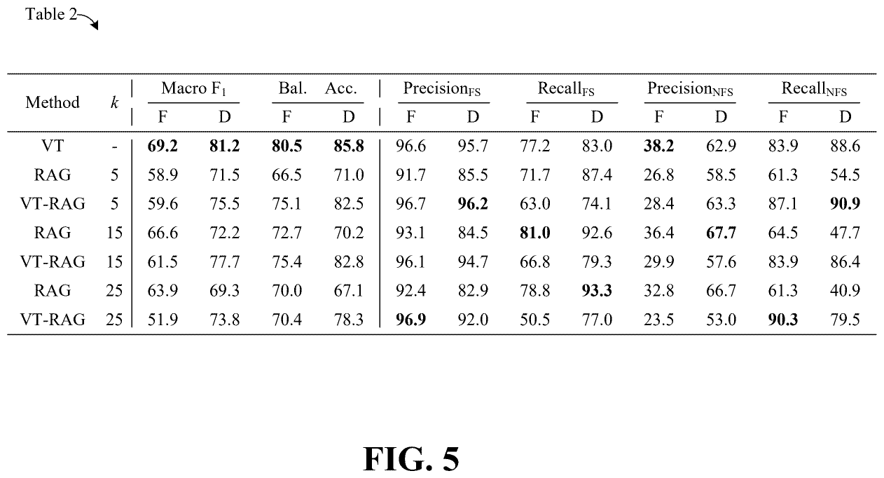

These methods were evaluated on a random subset of the data: 6 books from FABLES+ and 7 questions from DiverseSumm+, covering approximately one-third of the claims in each dataset. FIG. 5 shows the results produced using gpt-4o-2024-0806 in Table 2. Across both datasets, the original VeriTrail (VT) outperformed the other methods. For FABLES+, the observation VT>RAG>VT-RAG, suggests that VeriTrail's evidence selection step is the main reason it outperforms the other methods. For DiverseSumm+, the observation VT>VT-RAG>RAG, indicates that both the evidence selection step and tracing through intermediate outputs contribute to VeriTrail's performance gains.

Table 2 shows hard prediction results (%) on the FABLES+ (F) and DiverseSumm+ (D) datasets, comparing standard VeriTrail with q=1 (VT), RAG, and a hybrid method (VT-RAG). For RAG and VT-RAG, k denotes the number of top-ranked chunks retrieved. The process reports macro F1, balanced accuracy (Bal. Acc.), and class-specific precision and recall for fully supported (FS) and not fully supported (NFS) claims. Bolded values indicate the highest score per column.

To summarize some of the concepts introduced above, this disclosure addresses an underexplored but increasingly important technical challenge in hallucination detection: traceability for LM-based processes with multiple generative steps. The present concepts include VeriTrail, which is a technical solution involving the first closed-domain hallucination detection method that not only evaluates the output's faithfulness to the source, but also enables provenance tracing and error localization. For outputs deemed faithful, VeriTrail creates an evidence trail tracing the path to the source through intermediate outputs, whereas for unfaithful outputs it identifies the process stages where hallucination likely occurred-providing transparency and actionable insights into the generative process. Evaluating VeriTrail's performance involved creating the FABLES+ and DiverseSumm+datasets. Across both datasets, VeriTrail outperformed baseline methods in hallucination detection.

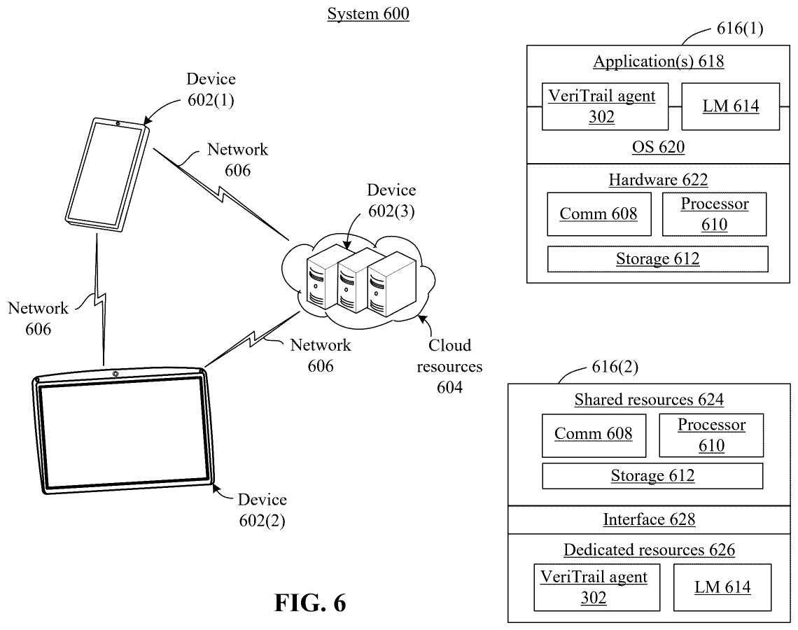

FIG. 6 shows an example faithfulness evaluation system 600. System 600 can include computing devices 602. In the illustrated configuration, computing device 602(1) is manifest as a smartphone, computing device 602(2) is manifest as a tablet type device, and computing device 602(3) is manifest as a server type computing device, such as may be found in a datacenter, such as a cloud resource 604. Computing devices 602 can be coupled via one or more networks 606 that are represented by lightning bolts. In some cases, some of the computing devices 602 can function as edge devices between other computing devices.

Computing devices 602 can include a communication component 608, a processor 610, storage resources (e.g., storage) 612, VeriTrail tool or agent 302 and/or a LM 614. The VeriTrail agent 302 can be implemented as an application, framework, and/or service. The VeriTrail agent 302 can be implemented locally (e.g., on a user's device), on an edge device, and/or remotely, such as in the cloud. The VeriTrail agent 302 interacts with LMs 614. The LMs may be on the same device as the VeriTrail agent 302 or a different device. For example, the LM 614 can be implemented locally (e.g., on a user's device), on an edge device, and/or remotely, such as in the cloud. Similarly, an individual device may include an instance of LM 614. For instance, device 602(2) may include a small language model that is employed by local VeriTrail agent 302. Alternatively, VeriTrail agent 302 on device 602(2) may access an LM 614 in the cloud resources 604.

In some configurations, the VeriTrail agent 302 can be configured to model a generative process based upon original source documents as a DAG. In some cases, the VeriTrail agent 302 can supply the original source documents to the LM 614 to generate the DAG. The DAG can represent the original source documents as root nodes and LM generated output as other nodes including a terminal node of the DAG. The VeriTrail agent 302 can be configured to split the terminal node into claims. The VeriTrail agent 302 can be configured to perform faithfulness evaluation on the claims by attempting to identify a provenance trace from an individual claim through individual other nodes to an individual root node.

FIG. 6 shows two device configurations 616 that can be employed by computing devices 602. Individual computing devices 602 can employ either of configurations 616(1) or 616(2), or an alternate configuration. (Due to space constraints on the drawing page, one instance of each configuration is illustrated). Briefly, device configuration 616(1) represents an operating system (OS) centric configuration. Device configuration 616(2) represents a system on a chip (SOC) configuration. Device configuration 616(1) is organized into one or more applications 618, operating system 620, and hardware 622. Device configuration 616(2) is organized into shared resources 624, dedicated resources 626, and an interface 628 therebetween.

In configuration 616(1), the VeriTrail agent 302 can be manifest as part of the operating system 620. Alternatively, the VeriTrail agent 302 can be manifest as part of the applications 618 that operate in conjunction with the operating system 620 and/or processor 610. In configuration 616(2), the VeriTrail agent 302 can be manifest as part of the processor 610 or a dedicated resource 626 that operates cooperatively with the processor 610.

In some configurations, each of computing devices 602 can have an instance of the VeriTrail agent 302. However, the functionalities that can be performed by the VeriTrail agent 302 may be the same or they may be different from one another when comparing computing devices. For instance, in some cases, each VeriTrail agent 302 can be robust and provide all of the functionality described above and below (e.g., a device-centric implementation). In other cases, some devices can employ a less robust instance of the VeriTrail agent 302 that relies on some functionality to be performed by another device.

The term “device,” “computer,” or “computing device” as used herein can mean any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 616(2) can be viewed as a system on a chip (SOC) type design. In such a case, functionality provided by the device can be integrated on a single SOC or multiple coupled SOCs. One or more processors 610 can be configured to coordinate with shared resources 624, such as storage 612, etc., and/or one or more dedicated resources 626, such as hardware blocks configured to perform certain specific functionality. Thus, the term “processor” as used herein can also refer to central processing units (CPUs), graphical processing units (GPUs), neural processing units (NPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

As noted above several device implementations are illustrated. As also noted, not all device implementations can be illustrated, and other device implementations should be apparent to the skilled artisan from the description above and below.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### TERMINOLOGY

For the purposes of this document, the term “language model” refers to any type of automated agent that communicates via natural language. For instance, a language model can be implemented as a neural network, e.g., a decoder-based generative language model such as ChatGPT, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Language Model

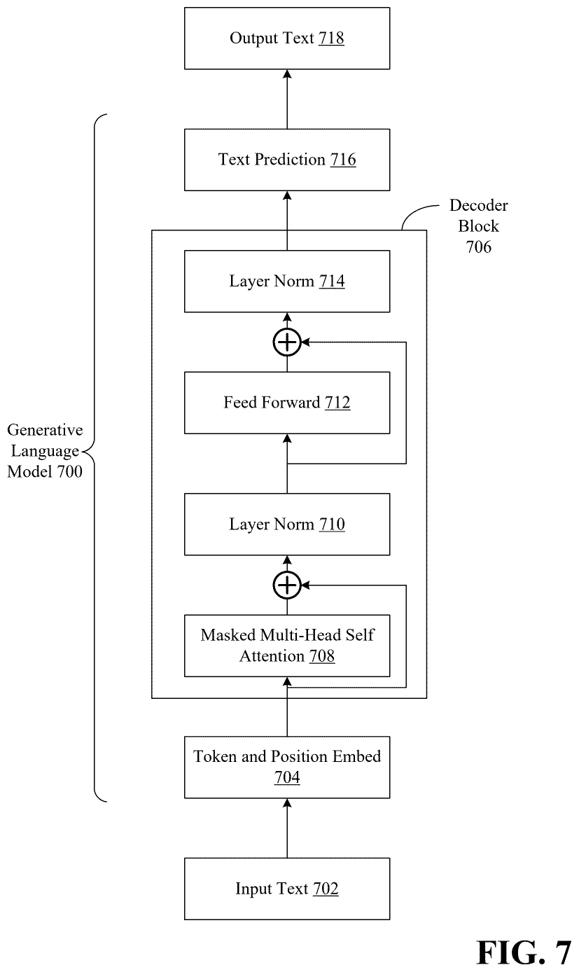

FIG. 7 illustrates an example generative model, such as generative language model 700 that can be employed using the disclosed implementations. Generative language model 700 is an example of a machine learning model that can be used to perform one or more natural language processing tasks that involve generating text, as discussed more below. For the purposes of this document, the term “natural language” means language that is normally used by human beings for writing or conversation.

Generative language model 700 can receive input text 702, e.g., a prompt from a user. For instance, the input text can include words, sentences, phrases, or other representations of language. The input text can be broken into tokens and mapped to token and position embeddings 704 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 704 are processed in one or more decoder blocks 706. Each decoder block implements masked multi-head self-attention 708, which is a mechanism relating different positions of tokens within the input text to compute the similarities between those tokens. Each token embedding is represented as a weighted sum of other tokens in the input text. Attention is only applied for already-decoded values, and future values are masked. Layer normalization 710 normalizes features to mean values of 0 and variance to 1, resulting in smooth gradients. Feed forward layer 712 transforms these features into a representation suitable for the next iteration of decoding, after which another layer normalization 714 is applied. Multiple instances of decoder blocks can operate sequentially on input text, with each subsequent decoder block operating on the output of a preceding decoder block. After the final decoding block, text prediction layer 716 can predict the next word in the sequence, which is output as output text 718 in response to the input text 702 and also fed back into the language model. The output text can be a newly-generated response to the prompt provided as input text to the generative language model.

### Example Methods

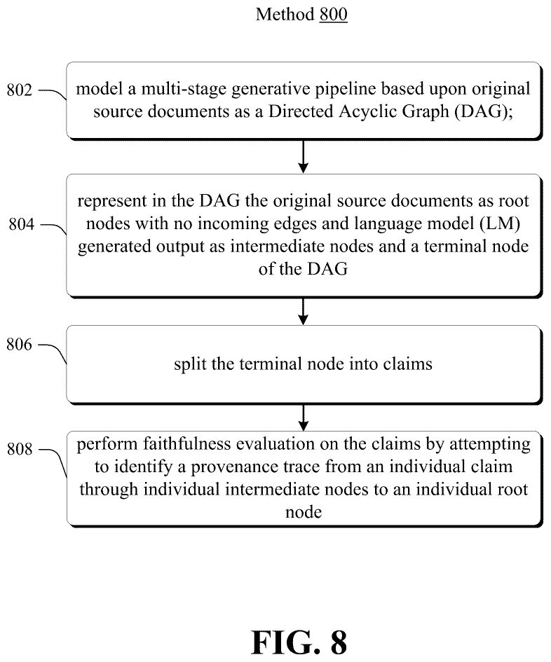

FIG. 8 shows a flowchart or method 800 associated with faithfulness evaluation concepts.

Block 802 can model a multi-stage generative pipeline based upon original source documents as a Directed Acyclic Graph (DAG).

Block 804 can represent in the DAG the original source documents as root nodes with no incoming edges and language model (LM) generated output as intermediate nodes and a terminal node of the DAG.

Block 806 can split the terminal node into claims.

Block 808 can perform faithfulness evaluation on the claims by attempting to identify a provenance trace from an individual claim through individual intermediate nodes to an individual root node.

The methods can be stored as computer-readable instructions that are executed by a processor of a computing device, such as the devices of FIG. 6.

### Additional Examples

Various device examples are described above. Additional examples are described below. One example includes a computer-implemented method comprising modeling a multi-stage generative pipeline based upon original source documents as a Directed Acyclic Graph (DAG), representing in the DAG the original source documents as root nodes with no incoming edges and language model (LM) generated output as intermediate nodes and a terminal node of the DAG, splitting the terminal node into claims, and performing faithfulness evaluation on the claims by attempting to identify a provenance trace from an individual claim through individual intermediate nodes to an individual root node.

Another example can include any of the above and/or below examples where the multi-stage generative pipeline comprises question-answering, summary generation, or document generation.

Another example can include any of the above and/or below examples where the individual root node comprises multiple root nodes.

Another example can include any of the above and/or below examples where the performing faithfulness evaluation comprises, for the individual claim, gathering evidence, generating verdicts, and iteratively backtracking.

Another example can include any of the above and/or below examples where gathering evidence starts with first intermediate nodes that are one edge removed from the terminal node, and further comprises splitting text corresponding to the first intermediate nodes into chunks, and assigning unique IDs to text segments in an individual chunk.

Another example can include any of the above and/or below examples where the text segments comprise sentences.

Another example can include any of the above and/or below examples where for individual chunks, prompting the LM to identify unique IDs of sentences that strongly support or refute at least part of the claim and generate a summary based on the identified sentences.

Another example can include any of the above and/or below examples where the method further comprises supplying the generated summaries to the LM in a prompt and receiving a verdict from the LM that indicates whether an individual identified sentence is fully supported, not fully supported, or inconclusive.

Another example can include any of the above and/or below examples where if the verdict for the individual identified sentence is fully supported, iteratively backtracking in the DAG toward the original source documents.

Another example can include any of the above and/or below examples where iteratively backtracking comprises identifying a subset of nodes from which at least one sentence was selected as relevant during evidence gathering, and further comprising for each of the subset of nodes, identifying underlying nodes used as context during generation of the subset of nodes.

Another example can include any of the above and/or below examples where the method repeats the iteratively backtracking until reaching the root nodes of the original source documents.

Another example can include any of the above and/or below examples where the method, for each claim, outputs the provenance trace for the individual claim through intermediate nodes to the individual root node.

Another example can include any of the above and/or below examples where when the individual identified sentence is not fully supported then further comprising identifying a node stage where an error was likely introduced.

Another example includes a system comprising storage configured to store computer-readable instructions and a processor configured to execute the computer-readable instructions to model a generative process based upon original source documents as a Directed Acyclic Graph (DAG), represent in the DAG the original source documents as root nodes and language model (LM) output as other nodes including a terminal node of the DAG, split the terminal node into claims, and perform faithfulness evaluation on the claims by attempting to identify a provenance trace from an individual claim through individual other nodes to an individual root node.

Another example can include any of the above and/or below examples where the processor is further configured to generate a user interface that includes the faithfulness evaluation.

Another example can include any of the above and/or below examples where the processor is further configured to present the DAG on the user interface.

Another example includes a computer-readable storage media storing computer-readable instructions that when executed, comprise receive a directed acyclic graph (DAG) including multiple stages with a lower stage relating to original content, an intermediate stage of summaries of the lower stage, and an upper stage that comprises a summary of the intermediate stage, extract a claim from a terminal node of the upper stage, identify candidate nodes in the intermediate stage and the lower stage that support the claim, perform evidence selection on the candidate nodes, and perform verdict generation by determining whether a continuous path occurs from the terminal node through an individual candidate node of the intermediate stage to an individual candidate node of the lower stage.

Another example can include any of the above and/or below examples where the computer-readable storage media further comprises presenting an evidence trail that supports the generated verdict.

Another example can include any of the above and/or below examples where the computer-readable storage media further comprises repeating the identifying, performing evidence selection and performing verdict generation for multiple extracted claims.

Another example can include any of the above and/or below examples where when a continuous path does not exist, providing error localization related to a path discontinuity.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
modeling a multi-stage generative pipeline based upon original source documents as a Directed Acyclic Graph (DAG);
representing in the DAG the original source documents as root nodes with no incoming edges and language model (LM) generated output as intermediate nodes and a terminal node of the DAG;
splitting the terminal node into claims; and,
performing faithfulness evaluation on the claims by attempting to identify a provenance trace from an individual claim through individual intermediate nodes to an individual root node.

2. The computer-implemented method of claim 1, wherein the multi-stage generative pipeline comprises question-answering, summary generation, or document generation.

3. The computer-implemented method of claim 1, wherein the individual root node comprises multiple root nodes.

4. The computer-implemented method of claim 1, wherein the performing faithfulness evaluation comprises:
for the individual claim, gathering evidence, generating verdicts, and iteratively backtracking.

5. The computer-implemented method of claim 4, wherein gathering evidence starts with first intermediate nodes that are one edge removed from the terminal node, and further comprises splitting text corresponding to the first intermediate nodes into chunks, and assigning unique IDs to text segments in an individual chunk.

6. The computer-implemented method of claim 5, wherein the text segments comprise sentences.

7. The computer-implemented method of claim 6, wherein for individual chunks, prompting the LM to:
identify unique IDs of sentences that strongly support or refute at least part of the claim; and
generate a summary based on the identified sentences.

8. The computer-implemented method of claim 7, further comprising:
supplying the generated summaries to the LM in a prompt; and
receiving a verdict from the LM that indicates whether an individual identified sentence is fully supported, not fully supported, or inconclusive.

9. The computer-implemented method of claim 8, wherein if the verdict for the individual identified sentence is fully supported, iteratively backtracking in the DAG toward the original source documents.

10. The computer-implemented method of claim 9, wherein iteratively backtracking comprises identifying a subset of nodes from which at least one sentence was selected as relevant during evidence gathering, and further comprising for each of the subset of nodes, identifying underlying nodes used as context during generation of the subset of nodes.

11. The computer-implemented method of claim 10, further repeating the iteratively backtracking until reaching the root nodes of the original source documents.

12. The computer-implemented method of claim 11, for each claim outputting the provenance trace for the individual claim through intermediate nodes to the individual root node.

13. The computer-implemented method of claim 8, wherein when the individual identified sentence is not fully supported then further comprising identifying a node stage where an error was likely introduced.

14. A system, comprising:
storage configured to store computer-readable instructions; and,
a processor configured to execute the computer-readable instructions to:
model a generative process based upon original source documents as a Directed Acyclic Graph (DAG);
represent in the DAG the original source documents as root nodes and language model (LM) output as other nodes including a terminal node of the DAG;
split the terminal node into claims; and,
perform faithfulness evaluation on the claims by attempting to identify a provenance trace from an individual claim through individual other nodes to an individual root node.

15. The system of claim 14, wherein the processor is further configured to generate a user interface that includes the faithfulness evaluation.

16. The system of claim 15, wherein the processor is further configured to present the DAG on the user interface.

17. A computer-readable storage media storing computer-readable instructions that when executed, comprise:
receive a directed acyclic graph (DAG) including multiple stages with a lower stage relating to original content, an intermediate stage of summaries of the lower stage, and an upper stage that comprises a summary of the intermediate stage;
extract a claim from a terminal node of the upper stage;
identify candidate nodes in the intermediate stage and the lower stage that support the claim;
perform evidence selection on the candidate nodes; and,
perform verdict generation by determining whether a continuous path occurs from the terminal node through an individual candidate node of the intermediate stage to an individual candidate node of the lower stage.

18. The computer-readable storage media of claim 17, further comprising presenting an evidence trail that supports the generated verdict.

19. The computer-readable storage media of claim 17, further comprising repeating the identifying, performing evidence selection and performing verdict generation for multiple extracted claims.

20. The computer-readable storage media of claim 17, wherein when a continuous path does not exist, providing error localization related to a path discontinuity.
